(19) United States
(12) Patent Application Publication
(10) Pub. No.: US 2026/0311359 A1
(43) Pub. Date: Oct. 8, 2026

(54) BODY MEASUREMENT MEASURING METHOD AND AUTOMATIC CLOTHING PATTERN GENERATION METHOD, FOR CONTACTLESSLY ORDERING AND MANUFACTURING CUSTOM-MADE CLOTHING

(71) Applicant: IFU INTERNATIONAL INC, Seoul (KR)

(72) Inventor: Miyoung CHA, Seoul (KR)

(73) Assignee: IFU INTERNATIONAL INC, Seoul (KR)

(21) Appl. No.: 19/478,688

(22) PCT Filed: Apr. 27, 2023
(86) PCT No.: PCT/KR2023/005752

§ 371 Date: Oct. 24, 2025

(51) Int. Cl. G06T 7/60; A41H 1/02; A41H 3/04; G06Q 30/0601; G06T 11/23

(52) U.S. Cl. CPC G06T 7/60; A41H 1/02; A41H 3/04; G06Q 30/06211; G06T 11/23; G06T 2207/30124; G06T 2207/30196

(57) ABSTRACT

A method for measuring body measurements and automatically generating clothing patterns for non-face-to-face custom-made clothing ordering and manufacturing, including: measuring body-type-specific body measurements from multiple subjects; generating reference patterns suitable for each subject and measuring pattern element dimensions for specific regions within each reference pattern; statistically analyzing the correlation coefficients between the body-type-specific body measurements and the pattern element dimensions to derive regression equations for calculating the dimensions of each region within a target pattern to be created from the actual measured body measurements of a clothing consumer; developing an automatic pattern-generation program by programming the regression equations and installing it on a computer; and inputting the actual measured body measurements as input variables into the automatic pattern-generation program so that the target pattern is automatically generated.

### TECHNICAL FIELD

The present invention relates to a method for measuring body measurements and automatically generating clothing patterns for non-face-to-face custom-made clothing ordering and manufacturing.

More specifically, the present invention relates to a technology for automatically, quickly, and accurately generating and providing clothing patterns suitable for a user's body in a non-face-to-face manner by capturing images using a portable mobile terminal, analyzing the captured images to measure the user's body measurements, including the angles and lengths of body parts, and generating clothing patterns suitable for the user based on the measured body information.

### BACKGROUND ART

Today, the demand for personalized and diverse designs of clothing consumers is increasing. In recent years, as consumers have placed greater emphasis not only on design but also on the fit of garments, the importance of garment fit has been steadily increasing in the apparel industry.

To improve garment fit, it is necessary to reflect body-shape factors that take into account various body types in addition to body circumference and length. To manufacture garments suitable for individual body shapes, the development of advanced personal customization technologies and precise individual pattern generation technologies is required.

Furthermore, the proportion of custom-made clothing in the fashion market is expected to grow. In addition to women's, casual, and luxury apparel, customized men's clothing, outdoor wear, and sportswear are also expected to significantly contribute to the future growth of the fashion industry.

Typically, to manufacture a garment, a pattern for each body region is created, the fabric is cut according to the created pattern, and the cut fabric pieces are sewn together to complete a single garment.

Therefore, in the personalized clothing market, it is most important to generate clothing patterns that accurately fit an individual's body shape based on precisely measured body data. The development of technologies capable of quickly and accurately generating customized patterns is required. In particular, when manufacturing one-to-one custom-made clothing, it is essential to accurately measure the consumer's body measurements.

Furthermore, when purchasing garments, buyers must know their exact body measurements to purchase clothing that fits well. Even if they know their approximate measurements, the actual size indicated on the garment may differ from their true body measurements. Therefore, sellers also need to know the buyer's accurate body measurements in order to provide well-fitting garments.

Accordingly, in order to achieve precise garment pattern drafting and garment manufacturing with excellent fit, and to minimize customer dissatisfaction and product returns caused by errors in body measurement, it is necessary to develop a technology capable of easily and accurately measuring body measurements.

Conventionally, a manual tape-measure method has been widely used, in which the body's length and circumference are measured with a tape measure, and a garment pattern is designed based on the obtained measurements before manufacturing the garment. However, it is difficult to accurately capture the three-dimensional shape of the body using only length and circumference values, and thus it is difficult to create patterns that properly fit the body or to achieve a satisfactory level of garment fit.

In addition, in conventional pattern making, a manual drafting method has been used in which only the chest circumference is measured, and the other body measurements are proportionally calculated based on the chest circumference to create an average pattern shape (so-called chest measurement method). Alternatively, each part of the body is measured individually, and the pattern shape is manually drafted by skilled artisans using a custom drafting method (so-called “Danchon” method).

However, these manual drafting methods require specialized expertise and significant time, and since every individual's body shape differs, creating patterns solely based on specific dimensions such as chest circumference often results in poor garment fit.

Moreover, when body-shape variations-such as the angles, thicknesses, and contours of respective body parts that differ by age or individual characteristics—are not taken into account, it becomes difficult to manufacture garments with a high level of fit.

In addition, the neck region of upper garments has little correlation with the chest circumference, and particularly the collar sewn around the neckline is almost unrelated to the chest circumference. As a result, there are limitations in creating collar patterns suitable for individual body shapes, which can lead to problems such as wrinkling around the neck or poor fitting due to an ill-suited collar shape.

Furthermore, no technology has yet been developed that can derive an optimal collar shape solely from individual body measurements. Consequently, the creation of collar patterns still relies heavily on the experience and intuition of skilled experts.

In addition, although pattern CAD systems have been introduced to replace manual methods, such systems merely facilitate pattern correction and grading by adjusting a basic pattern to match body measurements. However, since these systems essentially digitize existing manual patterns, they do not achieve true pattern automation.

Moreover, methods utilizing three-dimensional measuring devices (scanners) have the advantage of easily obtaining three-dimensional body-shape information. However, it is difficult to extract accurate two-dimensional patterns when converting three-dimensional body data into planar information, and the equipment requires skilled operation. Furthermore, the high cost of the devices limits their use, and employing such expensive equipment can increase production costs, particularly in custom-made clothing (personalized or tailored ready-made garments) or small-batch, multi-product manufacturing.

### SUMMARY OF INVENTION

### Problems to be Solved by Invention

Therefore, the present invention has been devised to overcome the above-described problems, and its object is to provide a method for measuring body measurements and automatically generating clothing patterns for non-face-to-face custom-made clothing ordering and manufacturing, which enables the rapid and accurate automated generation of clothing patterns suitable for an individual's body based on simple measurements of body angles and lengths.

Furthermore, another object of the present invention is to provide a method for measuring body measurements that allows simple and accurate non-face-to-face measurement of body sizes during clothing pattern drafting or garment purchasing.

In addition, still another object of the present invention is to provide a method that enables even non-experts to measure body measurements from images captured using a portable mobile device, without requiring skilled expertise or expensive 3D measuring equipment, and to automatically generate clothing patterns based on the measured data.

Moreover, a further object of the present invention is to provide a method for generating clothing patterns that can contribute to cost reduction and inventory minimization by automatically generating personalized patterns for a large number of individuals, rather than using ready-made garment patterns based on average measurements, without experts or costly devices.

In particular, the present invention aims to provide a method for automatically generating one-to-one personalized patterns that best fit an individual's body type, taking into account body shape variations due to age or personal characteristics, without relying on manual processes.

### Means for Solving Problems

To achieve the above object, the present invention provides a method for measuring body measurements and automatically generating clothing patterns for non-face-to-face custom-made clothing ordering and manufacturing, which includes: selecting multiple subjects and measuring the dimensions of each predetermined body part of each subject to obtain actual measured body measurements of the subject; measuring the dimensions of each predetermined body part from photographs taken of each subject; deriving a regression equation for calculating actual body measurements of a clothing consumer from the body measurements in photographs taken of the clothing consumer, by performing statistical processing involving correlation analysis and regression analysis between the actual measured body measurements of the subject and the measurements of each body part of each subject measured in the photographs; developing a measurement program based on the regression equation to calculate the actual body measurements of the clothing consumer from the body measurements in the photographs taken of the clothing consumer, and storing the program on a server; capturing an image for measuring the body measurements of the clothing consumer using a portable mobile terminal, and transmitting the captured image to the server from the mobile terminal; measuring, by the server, the dimensions of predetermined body parts from the image taken of the clothing consumer using the measurement program; and inputting the measurements of the body parts measured from the photographs of the clothing consumer as input variables into the measurement program, such that the actual measured body measurements of each body part of the clothing consumer are calculated by the measurement program.

In addition, the actual measured body measurements of the subject may include at least one selected from the group consisting of the measurements of an angle of a body part, and a length, circumference, width, or thickness of the body part measured in units of length.

Further, in the step of measuring the dimensions of each predetermined body part from the photographs of the subjects and the clothing consumer, the subject and the clothing consumer may be photographed together with a size measuring member formed of a standardized product, and the dimensions of each body part may be measured in proportion to the dimensions of the photographed size measuring member.

Further, multiple photographs may be taken while changing, at predetermined angular intervals, the direction in which the subject and the clothing consumer are standing against the size measuring member.

Furthermore, the direction in which the subject and the clothing consumer are standing may be changed in 45° increments, and photographs may be taken in a total of eight directions including the front, back, left, and right sides of the subject.

Furthermore, multiple photographs may be taken at different photographing distances for each direction in which the subject and the clothing consumer are standing, and the unit of change in the photographing distance may be defined as the length of one or more size measuring members arranged in a straight line in one direction.

Furthermore, when deriving a regression equation for calculating the actual measurements of each body part of a clothing consumer from the body measurements in photographs taken of the clothing consumer, statistical analysis may be performed for each photographing distance to derive multiple regression equations distinguished by photographing distance for each body part, and the regression equation corresponding to the photographing distance at which the photograph of the clothing consumer is taken may be selected and used to calculate the actual body measurements of the clothing consumer.

Furthermore, the body part of the subject whose actual body measurements are measured and the body part whose measurements are obtained from the photograph of the subject may be defined as the same body part.

Furthermore, during the statistical processing involving correlation analysis and regression analysis, the correlation between the actual measured body measurement data of each subject and the body part measurement data of each subject obtained from photographs may be analyzed as variables, photographic body measurement items having correlation with the actual measured body measurements may be extracted, and a regression analysis may be performed using the photographic body measurement items having correlation with the actual measured body measurements of the subject as independent variables to derive the regression equation.

Furthermore, the regression equation may be a regression equation that uses, as variables, both the dimensions of body parts measured in photographs of the clothing consumer and the actual measured body measurements of other body parts of the clothing consumer that have been pre-calculated.

In addition, the method may further include generating a reference pattern fitted to the body shape of each of the multiple subjects, and measuring pattern element dimensions, which are the measurements of predetermined regions within each reference pattern; performing statistical processing involving correlation analysis and regression analysis between the body-type-specific body measurements and the pattern element dimensions to derive a regression equation for calculating the dimensional values of each region within a target pattern from the body measurements obtained for the clothing consumer; based on the regression equation, calculating the dimensional values of each region within the target pattern from the body measurements of the clothing consumer obtained from photographs taken of the clothing consumer, and developing an automatic pattern-generation program that uses the calculated dimensional values of each region to generate the target pattern, and storing the program on a server; inputting, by the server, the body measurements of the clothing consumer as input variables into the automatic pattern-generation program, so that the target pattern for the clothing consumer is automatically generated by the automatic pattern-generation program; and providing the automatically generated target pattern of the clothing consumer to a mobile terminal of the clothing consumer or of a garment manufacturer.

Further, the body measurements of the clothing consumer may include at least one selected from the group consisting of the measurements of an angle of a body part, and a length, circumference, width, or thickness of the body part measured in units of length.

Furthermore, in the step of obtaining the body-type-specific body measurements, a human body model replicating the body of each subject may be fabricated, and the body measurements of each body part may be measured using each human body model to obtain the body-type-specific body measurements.

Furthermore, the human body model may be fabricated by applying plaster to the body of each subject, allowing the plaster to harden, then separating it to produce a plaster mold, applying a release agent and liquid resin to an inner surface of the mold, and separating the hardened resin from the mold.

Furthermore, the human body model may be made of a fiber-reinforced plastic material.

Furthermore, the step of obtaining body-type-specific body measurements may include photographing each human body model together with a size measuring member, and measuring the dimensions of each predetermined body part in proportion to the dimension of the size measuring member shown in the captured images.

Furthermore, when generating a reference pattern suitable for each subject's body type, each human body model may be used to create a reference pattern corresponding to the body shape of the human body model.

Furthermore, the pattern element dimensions may be angle and length measurements taken from predetermined regions within the reference pattern.

Furthermore, during the statistical processing involving correlation analysis and regression analysis, the correlation between the body-type-specific body measurement data and the pattern element dimension data may be analyzed as variables, body-type-specific body measurement items having correlation with the pattern element dimensions may be extracted, and a regression analysis may be performed using the extracted body-type-specific body measurement items as independent variables to derive the regression equation.

Furthermore, the regression equation uses, as variables, at least one selected from the group consisting of the measurements of a body part measured for a clothing consumer, pre-calculated measurements of another body part within the target pattern, preset measurements input in advance for a specific body part within the target pattern, and pre-calculated measurements of another target pattern that constitutes a clothing pattern for manufacturing a garment together with the target pattern.

Furthermore, the automatic pattern-generation program may be configured to draw curved portions within the target pattern using the Hermite curve drawing method, which draws curves based on a distance between two points and angles at those points.

Furthermore, the body part of the subject whose actual body measurements are measured and the body part whose measurements are obtained from the photograph of the subject are defined as the body parts for which dimensional measurements may be required when drafting a clothing pattern.

### Advantageous Effects

Therefore, the body measurement method and automatic clothing pattern generation method for non-face-to-face custom-made clothing ordering and manufacturing according to the present invention provide the following effects.
1) Body measurements can be easily and accurately obtained simply by taking a photograph. For example, when drafting a clothing pattern or purchasing garments, a clothing consumer can conveniently and precisely acquire the required body measurements merely by photographing their own body, thereby improving measurement convenience. In this case, the consumer may capture their body image using a camera of a smart device (e.g., smartphone or tablet PC) or a digital camera and transmit the captured image. A computer in which a measurement program is installed can then accurately calculate the dimensions for each body part of the consumer, which can be applied to clothing pattern drafting and other related processes.
2) In both the ready-made garment and custom-made clothing markets, the ability to accurately measure body measurements of the clothing consumers enables consumers to obtain garments with excellent fit, thereby enhancing overall satisfaction of the consumers. This is particularly beneficial for consumers who are unaware of their exact body measurements or are confused by differing size specifications among brands, as they can still receive garments that accurately fit their bodies.
3) Since clothing consumers can purchase garments that accurately reflect their own body measurements, product return rates can be significantly reduced.
4) Without requiring expert skills or expensive equipment such as 3D measuring devices, even non-experts can remotely measure body measurements using images captured through a portable mobile device. Based on the obtained body measurements, clothing patterns suitable for the user's body can be automatically generated quickly and accurately.
5) By automatically generating personalized patterns for a large number of individuals, rather than producing ready-made garment patterns based on average dimensions, without the need for experts or costly devices, production costs can be reduced and inventory can be minimized.
6) In particular, the method enables automated generation of one-to-one personalized patterns that optimally fit individual body types, reflecting body-shape variations according to age and personal characteristics, without requiring manual work.
7) In the custom-made or semi-custom (semi-tailored) clothing market, garments achieving a high level of fit satisfaction can be produced within a short manufacturing period while achieving a fit comparable to that of individualized (one-to-one) bespoke garments. This approach eliminates the inconvenience of fittings typically required for individualized customization. In addition, by reducing production stages, manufacturing costs can be lowered, allowing custom garments to be offered at prices comparable to ready-made garments.
8) Small-scale companies in the custom pattern market can also more easily produce high-quality custom-made clothing.

### BRIEF DESCRIPTION OF DRAWINGS

FIG. 1 is a view illustrating an example of photographing by changing the photographing direction in the present invention.

FIG. 2 is a view illustrating an example of a foot board used for photographing in the present invention.

FIG. 3 is a view illustrating a scale background board and a foot board used for photographing in the present invention.

FIG. 4 is a view illustrating actual measurement regions of a subject and the corresponding measurement regions on a photograph in the present invention.

FIG. 5 is a view illustrating angles of respective body parts measured on the actual body of a subject and the corresponding angles measured on a photograph in the present invention.

FIGS. 6 and 7 are views illustrating that the dimensions of respective body parts vary depending on the photographing direction in the present invention.

FIG. 8 is a view illustrating an input screen of a measurement program in the present invention.

FIG. 9 is a view illustrating characteristics of body shapes and patterns according to age in the present invention.

FIG. 10 is a view illustrating a method of photographic measurement using a human body model in the present invention.

FIG. 11 is a view illustrating the process of three-dimensional cutting of an upper body using a human body model in the present invention.

FIGS. 12 and 13 are views illustrating examples of reference patterns obtained by three-dimensional cutting of a human body model in the present invention.

FIGS. 14 and 15 are views illustrating names of respective parts of a shirt collar in the present invention.

FIG. 16 is a view illustrating names of respective parts in a collar pattern for manufacturing a shirt collar in the present invention.

FIGS. 17 and 18 are views illustrating measurement regions of reference patterns obtained through three-dimensional cutting from respective human body models in the present invention.

FIGS. 19 to 23 are views illustrating actually measured body measurement regions serving as input variables for the automatic pattern-generation program in the present invention.

FIG. 24 is a view illustrating main variable items used for calculating the raised dimension of a collar pattern in the present invention.

FIG. 25 is a view illustrating an example of photographic measurement in the present invention.

FIG. 26 is a view illustrating an input screen of the automatic pattern-generation program in the present invention.

### MODE FOR CARRYING OUT INVENTION

Hereinafter, embodiments of the present invention will be described in detail with reference to the accompanying drawings so that those skilled in the art to which the invention pertains may easily carry out the invention.

The present invention provides a body measurement method that enables simple and accurate measurement of body measurements using a portable mobile device, such as a smartphone, during clothing pattern drafting or garment purchasing. Furthermore, the present invention aims to automatically generate and provide clothing patterns based on the measured body measurements.

To achieve this, the present invention provides a method capable of accurately deriving body measurements solely through photography and utilizes a pre-developed measurement program capable of precisely calculating the actual body measurements of a person in a photograph, using photographic body measurements obtained from captured images.

Here, the person shown in the captured image refers to a clothing consumer who intends to manufacture or purchase garments for themselves using the final measured body measurements for clothing pattern drafting or garment purchasing.

First, to implement the body measurement program on a server or mobile device, the program is developed through preliminary preparation and statistical analysis. The process of developing this measurement program is described as follows.

To develop the measurement program, subjects of various ages and body types, or an unspecified number of participants, are selected. From these selected subjects, the body measurements of each predetermined body part, such as the angles and lengths (including the circumference, width, and thickness of the predetermined body parts measured in units of length), are measured and collected.

Hereinafter, in this specification, the body measurement data acquired from subjects for the development of the measurement program-namely, the body measurements of each predetermined body part (including body angle and length information)—will be referred to as “actual measured body measurements of the subject.”

The actual measured body measurements of the subject required for developing the measurement program, which serves as a preliminary process of the present invention, may be obtained by measuring each subject using a tape measure, a protractor, or equivalent measuring instruments.

Next, a photograph of each subject is taken together with a size measuring member formed of a standardized product. The size measuring member may be any known product having a standard size, and preferably an easily obtainable A4-sized sheet. In one embodiment of the present invention, for higher measurement accuracy, the size measuring member may be a scale background board having grid-shaped scales (for example, horizontal and vertical scales spaced at 5 cm intervals).

At this stage, the size measuring member is preferably attached to a wall positioned behind the subject, and photographs are sequentially taken while the subject stands in front of the size measuring member. For each subject, photographs are taken in multiple directions by changing the orientation of the subject at fixed angular intervals, with the size measuring member serving as the background.

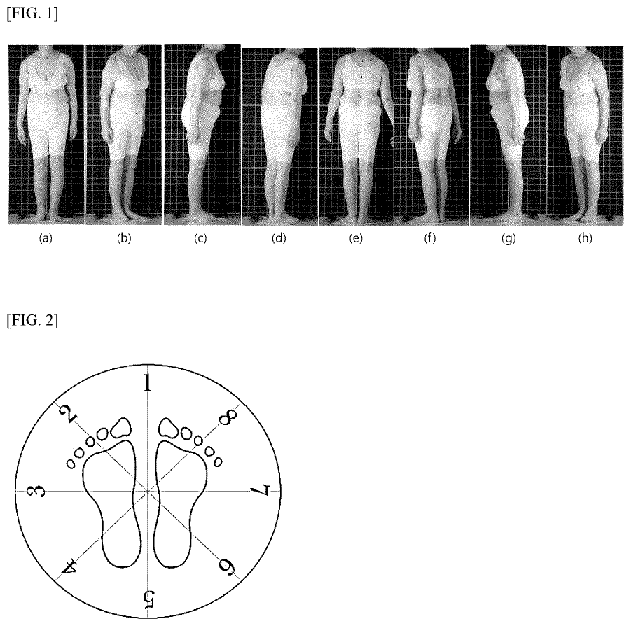

For example, as shown in FIGS. 1(a) to (h), the subject is positioned in front of the size measuring member facing forward and photographed. Then, the orientation of the subject is sequentially changed in 45° increments, and a photograph is taken at each orientation. In this case, to facilitate recognition of the direction, the size measuring members may be arranged in a predetermined layout beneath the subject's feet. For instance, multiple A4 sheets may be aligned, or alternatively, the A4 sheets may be folded to guide the subject in recognizing the photographing direction.

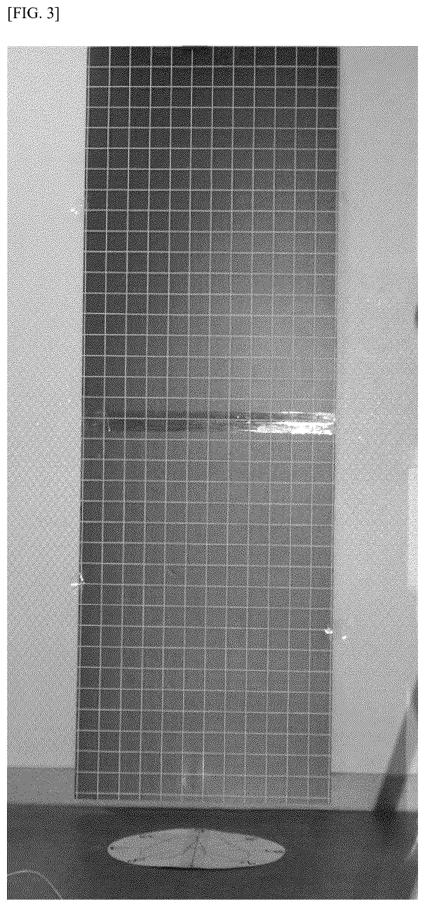

In addition, as shown in FIG. 2, a foot board marked with eight directions may be used. While the subject stands on the foot board, the direction of the subject's gaze is changed in 45° increments according to the directional markings on the foot board, and photographs are taken in each orientation while the subject maintains an upright posture. Accordingly, a total of eight photographs may be obtained for each subject, including front, rear, and left and right side views.

Furthermore, during photographing of the subject, the photographing distance may be varied for each subject and direction so that photographs are taken at different distances. For example, to identify image distortion that occurs at short range, photographs may be taken at multiple distances by changing the photographing distance in predetermined increments (for example, 1 m) from a minimum of 3 m to a maximum of 10 m. In this case, the unit of change in the photographing distance may be defined by one or more size measuring members arranged in a straight line in one direction.

In addition, for each photographing session, photo measurement information such as the position of the size measuring member, the user's facing direction, and the photographing distance is recorded.

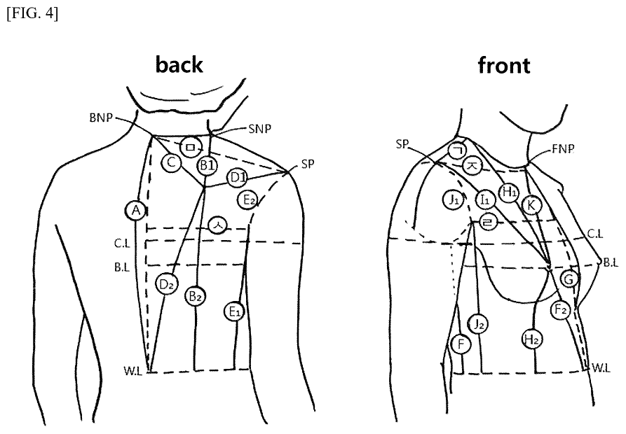

FIG. 3 illustrates one embodiment in which a scale background board and a foot board are used as size measuring members during photographing. The dimensions (scale intervals) of the scale background board are not particularly limited, and the foot board is also not limited as long as it can indicate the directions to the subject. In this embodiment, the angle of directional change during photographing is not limited to 45°, and FIG. 2 illustrates an example of a foot board fabricated by drawing straight lines radially from the center at 45° intervals, allowing the subject's direction to be changed in 45° increments.

Meanwhile, in each photograph taken at different distances and directions, the body measurements (body angle and length information) of each predetermined body part of the subject are measured. At this time, the body measurement regions in the photograph, where the angles and lengths are measured, correspond to the regions where actual body measurements of the subject were taken (actual measured regions of the subject). Both the photographic body measurement regions and the actual measured regions of the subject may be defined as body regions required for clothing pattern drafting.

To measure the body measurements in the photographs, a known image editing program such as Adobe Photoshop may be used. Assuming that all photographs taken from the same distance have identical scale intervals, the functions provided by the image editing program may be used to determine the length (distance) between two measurement points of each body part and the angle (angle between two straight lines) of each body part.

As described above, when obtaining the dimensions for each body part of the subject (actual measured body measurements) of the subject using a tape measure for length measurement and a protractor for angle measurement, or when obtaining photographic body measurements of each body part, various measurement regions may be predefined. These measurement regions may correspond to body parts for which dimensions are required in clothing pattern drafting, and a large number of measurement regions may be defined to ensure that the resulting clothing pattern accurately fits the body shape.

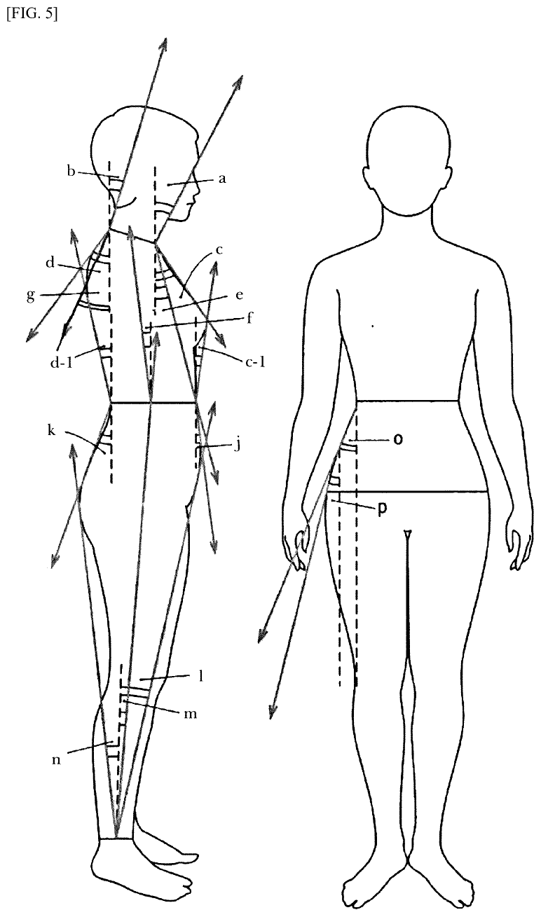

FIG. 4 is a view illustrating actual measured regions of a subject and corresponding measurement regions on a photograph in the present invention. When measuring each body part of the subject to obtain subject's actual measured body measurements, and when measuring each body part of the subject in photographs taken from different directions to obtain photographic body measurements, the measurements may be performed at the same predetermined body regions.

Furthermore, as described below, when photographing a clothing consumer's body to obtain final body measurements from the captured image, the body measurement regions of the consumer in the photograph and the target regions for the final measurements may be defined as the same regions. In this case, all body measurement regions may correspond to the body parts required for clothing pattern drafting.

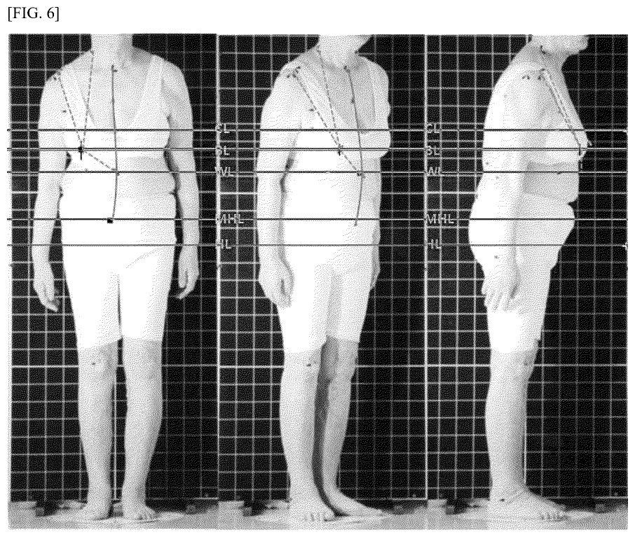

FIG. 5 is a view illustrating angles of respective body parts measured on the actual body of a subject and corresponding angles of respective body parts measured in a photograph in the present invention. When photographing a clothing consumer's body to obtain final body measurements from the captured image, the angles of the consumer's body parts measured in the photograph and the actual angles of the consumer's body parts, which are derived as final measurement values through a calculation formula, may correspond to the angles illustrated in FIG. 5.

Once the body measurements of the subject in the photograph are obtained, a photographing-distance-specific calculation formula capable of determining actual body measurements is derived using both the photographic body measurements of each body part of the subject and the actual measured body measurements of the subject. The derived calculation formula is then programmed, thereby completing a measurement program.

Here, the calculation formula is used to calculate the actual body measurements of a clothing consumer, who intends to manufacture or purchase clothing, from the photographic body measurements based on the captured image of the consumer.

Hereinafter, the process of deriving a calculation formula for obtaining actual body measurements from the photographic body measurements will be described in detail. For each photographing distance, statistical analyses such as correlation analysis and regression analysis may be performed using the previously obtained photographic body measurement data for each body part of the subject according to photographing distance and direction, together with the actual measured body measurement data of each subject. Through this process, a calculation formula defining the relationship between the photographic body measurements and the actual measured body measurements is derived for each photographing distance.

For reference, when photographic body measurements are taken for predetermined body parts in each directional photograph of FIGS. 1(a) to (h), even the same body part may exhibit different measurements depending on the photographing direction, as shown in FIGS. 1(a) to (h). Therefore, the dimensions for each body part obtained from photographs in each direction are subjected to statistical analysis by distinguishing the photographing directions.

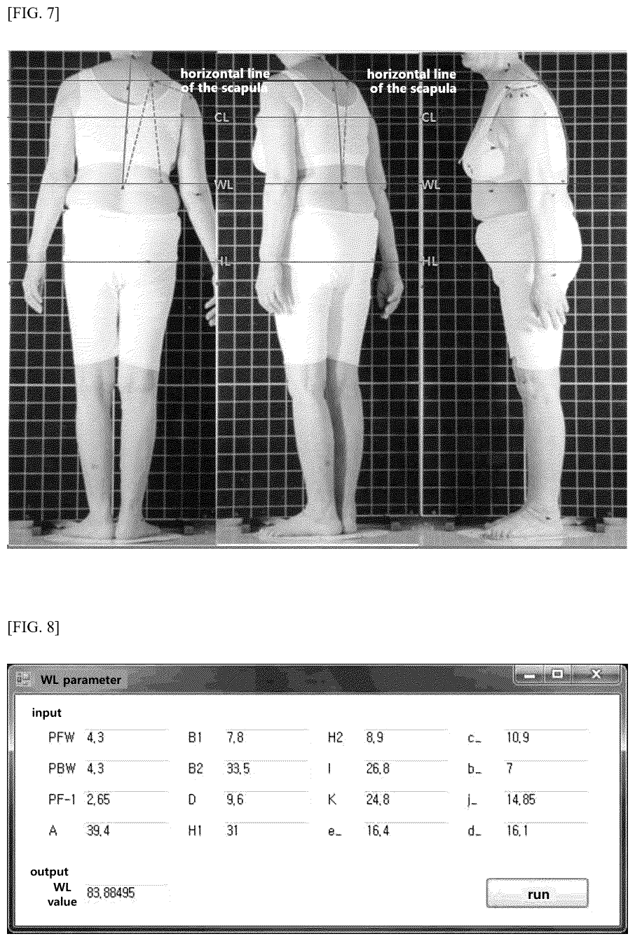

That is, as shown in FIGS. 6 and 7, for each protruding body part, such as the area around the scapula used as a reference point, the measurements vary depending on the photographing direction, even for the same region. Accordingly, the measurements taken in each direction for the same body part (that is, each measurement obtained from each directional photograph) may be considered as independent variables in the statistical analysis.

FIG. 6 illustrates various measurements of respective body parts around the chest in a photograph of a subject, and FIG. 7 illustrates various measurements of respective body parts around the scapula.

The correlation analysis may be performed to extract photographic body factors that influence the measurements of specific body parts of the subject. In this analysis, the subject's actual measured body measurement data obtained by measuring each body part of the subject and the photographic body measurement data for each body part according to photographing direction are used as variables. The correlation between these two variables is analyzed to identify photographic body measurement items that affect the actual measured body measurements of specific body parts of the subject. Photographic body measurement items exhibiting a high correlation with the actual measured body measurements of each subject are then identified.

Subsequently, based on the results of the correlation analysis, a regression analysis is performed to derive a calculation formula defining the relationship between the actual measured body measurements of each subject and the corresponding photographic body measurement data. The regression analysis uses multiple photographic body measurement items, as independent variables, that have high correlation coefficients with the actual measured body measurements for each body part of the subject as a result of the correlation analysis, thereby obtaining a regression equation for calculating the actual body measurements of each body part of a clothing consumer from the consumer's captured images.

These regression equations for each body part are used as calculation formulas for deriving the actual body measurements of the clothing consumer from the consumer's photographic body measurements. Furthermore, even for the same body part, multiple calculation formulas may be derived depending on the photographing distance as calculation formulas for each body part.

In addition, in the calculation formulas for deriving the actual body measurements of each body part of the clothing consumer (which may be individually obtained according to the photographing distance), the variables may include the photographic body measurements of various body parts in the photographs taken from different directions of the clothing consumer.

Here, in each individual calculation formula for deriving the actual measurements of each body part of the clothing consumer, the variables may include the photographic body measurements obtained from the images of the consumer's body parts. In addition to these photographic measurements, the pre-calculated actual measurements of other body parts of the consumer may also be used as additional variables in the calculation formula.

That is, once the actual measurement of a certain body part of the clothing consumer has been obtained, this previously obtained actual measurement may be additionally used as a variable so that the actual measurements of other body parts of the consumer are derived through the calculation formulas corresponding to those parts.

In this manner, the calculation formulas for deriving the measurements of each body part of the clothing consumer are obtained as regression equations that use, as variables, the photographic body measurements of each body part of the clothing consumer, and optionally, the pre-calculated actual measurements of other body parts of the consumer. The obtained regression equations are then used to calculate the actual body measurements from the photographic body measurements.

Table 1 below illustrates an example of a calculation formula. This example shows a case in which a multiple regression equation obtained through regression analysis is used as the calculation formula, and demonstrates how various body measurement variables obtained from photographs of the clothing consumer may be used to calculate an actual body measurement of the consumer, such as waist circumference.

TABLE 1

| | | | | | | r | | [symbol] |
|---|---|---|---|---|---|---|---|---|
| Y | X | | Partial | | | Partial | B | Multiple |
| Dependent | Independent | | Regression | | e | Correlation | Contribution | Regression |
| Variable | Variable | | Coefficient | | Constant | Coefficient | Rate | Equation |
| Waist | X₁ | PFW | B₁ | 30.7111 | −11.262 | [symbol] | [symbol] | [symbol] |
| Circumference | X [symbol] | [symbol] | B₂ | −16.037 | | | | |
| | X [symbol] | PF-1 | B₃ | 19.912 | | | | |
| | X [symbol] | A | B₄ | 1.117 | | | | |
| | X [symbol] | B1 | B₅ | [symbol] | | | | |
| | X [symbol] | B2 | B₆ | [symbol] | | | | |
| | X [symbol] | [symbol] | B₇ | 1.305 | | | | |
| | X [symbol] | H1 | B [symbol] | −5.237 | | | | |
| | X₉ | H2 | B [symbol] | −0.442 | | | | |
| | X [symbol] | [symbol] | B₁₀ | [symbol] | | | | |
| | X [symbol] | K | B [symbol] | [symbol] | | | | |
| | X₁₂ | [symbol] | B12 | −1.280 | | | | |
| | X [symbol] | C_{—} | B₁₃ | 0.161 | | | | |
| | X₁₄ | b_{—} | B [symbol] | 2.807 | | | | |
| | X [symbol] | [symbol] | B₁₅ | 1.955 | | | | |
| | X [symbol] | d_{—} | B₁₆ | −1.924 | | | | |

[symbol]

indicates data missing or illegible when filed

While not all variable symbols used in the calculation formulas are shown in the drawings, examples of the variables include B1 and B2, which represent photographic body measurements around the protruding portion of the scapula in photographs of the clothing consumer, as shown in FIG. 4.

In this manner, to calculate the actual body measurements of a specific body part of the clothing consumer, photographic measurements of other body parts may be used as variables in the calculation formula.

The calculation formula for waist circumference illustrated in Table 1 was derived solely using variables obtained from the frontal photograph of the clothing consumer, as shown in FIG. 1(a). Even in this case, a calculation formula (multiple regression equation) exhibiting a high contribution rate of 90.8% was derived. If additional variables (photographic body measurement items) obtained from photographs taken in multiple directions are further incorporated, a calculation formula with an even higher contribution rate may be derived and utilized.

Once the calculation formulas for each body part used to derive actual body measurements from photographic body measurements are obtained through statistical analysis (for example, multiple regression equations such as those shown in Table 1), these multiple regression equations are programmed to develop the measurement program, which is then stored in a server or computer.

The multiple regression equations used as the calculation formulas in the measurement program are derived through statistical analyses conducted for each photographing distance and are stored as photographing distance-specific regression equations. In actual use, when photographing a clothing consumer, the regression equation corresponding to the photographing distance is selected and applied to calculate the actual body measurements.

After the measurement program is installed on a computer, it may be used to accurately measure a user's body measurements simply by having the user take a photograph using a portable mobile device.

Here, the term “user” should be interpreted broadly to refer to any individual requiring accurate body measurements. However, in cases where the final measured body measurements are used for clothing pattern drafting or garment purchasing, the user corresponds to a clothing consumer who intends to manufacture or purchase garments for themselves.

In this manner, the body measurements of the user ultimately obtained according to the present invention may be utilized for various purposes beyond clothing pattern drafting or garment purchasing. Accordingly, as used herein, the term “user” is not limited to a clothing consumer. However, for convenience of description, the following explanation will refer to a clothing consumer as an example.

First, a clothing consumer who requires body measurements is guided, through an application installed on a portable mobile device, to take photographs. Preferably, the photographs are taken together with a size measuring member. Accordingly, the clothing consumer take a photograph of themselves together with the size measuring member, and the mobile device transmits the captured photographs to a server or computer on which the measurement program is stored via a communication network.

In this case, the size measuring member may be a standard product that is easily obtainable locally, or a product previously provided to the consumer by a clothing seller or manufacturer. It is also preferable that the photographs are taken directly using the camera of the portable mobile device through a pre-developed application installed therein. The obtained photographs are then transmitted, via a communication network, to a server or computer equipped with the measurement program.

Furthermore, the consumer may be guided to take photographs in all predetermined directions (for example, eight directions at 45° intervals). In this case, the consumer may be guided to recognize the photographing angle using the size measuring member. For example, when the size measuring member is an A4 sheet, the application may guide the consumer to fold the A4 sheet in a specific direction so that the consumer can face the predetermined direction while standing for photographing. The consumer may also be guided to take photographs at predetermined distances, for example, within a range of 3 m to 10 m. In this case, multiple size measuring members may be arranged in a straight line to help the consumer recognize the distance in predetermined units. A portable mobile device such as a smart device (e.g., smartphone or tablet PC) may be used for photographing; however, the present invention is not limited thereto, and any photographing means capable of capturing digital images, such as a digital camera, may also be used.

In addition, the height of the camera lens center during photographing may vary depending on the clothing item to be measured. For example, when the clothing item desired by the consumer is a full-body garment, it is preferable to align the camera lens center with the consumer's waist level. For an upper-body garment, it is preferable to align the camera lens center with the consumer's chest level, and for a lower-body garment, with the consumer's hip level.

The photographs taken in this manner are transmitted to the server or computer equipped with the measurement program and are used to calculate body measurements. When photographing is performed remotely using a smart device, the captured photographs may be directly transmitted from the smart device to the server or computer for input through an online transmission method.

Once the photographs of the consumer are obtained, adjustment of the image size may be required. A preprocessing step may be performed using the size measuring member shown in the photograph to enlarge or reduce the image so that it corresponds to the standard scale.

That is, since consumers may take photographs in various sizes, the captured images may have a non-standard size. Accordingly, the size of the captured image is adjusted so that the size measuring member shown in the photograph corresponds to the predetermined standard size, thereby obtaining an image suitable for accurate body measurement.

Such image size adjustment may be performed using a separate image editing program, which may also be used to obtain the dimensions (angles and lengths) of each body part shown in the photograph.

At this time, the body parts whose angles and lengths are measured in the photograph correspond to those shown in FIG. 4, that is, the same body parts that were measured earlier to derive the calculation formulas.

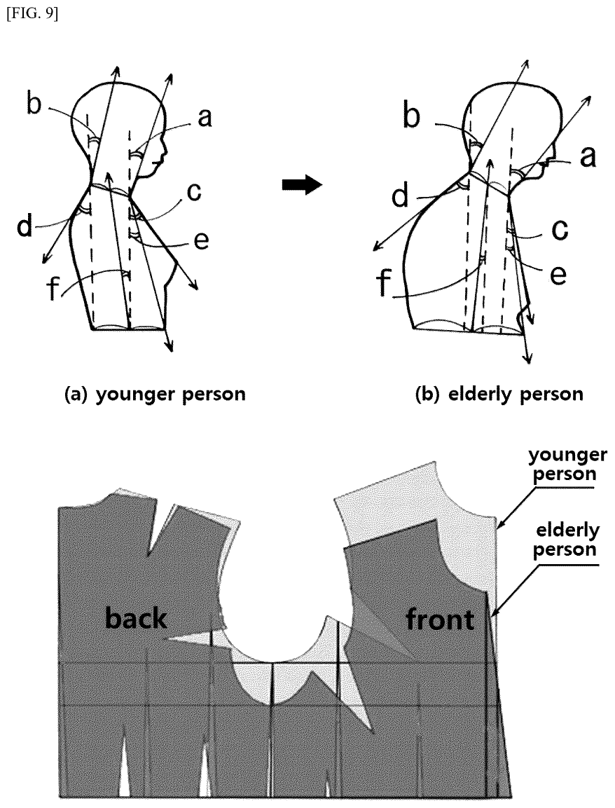

Ultimately, when the photographic body measurements are input as variables into the measurement program, as shown in FIG. 8, the regression equations stored in the program calculate the actual measurements of each body part of the consumer. FIG. 8 illustrates an example of an input screen for calculating the waist circumference (WL) using the photographic body measurements of the clothing consumer as variables.

In addition, during photographing, the clothing consumer takes photographs from a distance corresponding to the predetermined photographing distance applied when deriving the calculation formulas. The measurement program may also be configured to include regression equations for multiple photographing distances defined at predetermined intervals. In this case, when the photographing distance used by the consumer is input as a variable, the regression equation corresponding to that distance is automatically selected and applied from among the distance-specific calculation formulas.

Meanwhile, as described above, the present invention is designed to automatically and accurately generate and provide a clothing pattern suitable for an individual's body based on simple measurements of body-part angles and lengths obtained from photographs captured with a portable mobile device, without requiring expert skills or expensive equipment.

Furthermore, in consideration of variations in body shape depending on age and individual characteristics, the present invention enables the automated generation of one-to-one personalized patterns most suitable for individual body types, instead of relying on manual work.

To this end, the present invention employs an automatic pattern-generation program that, upon input of body-part angle and length measurements for predetermined body regions of a clothing consumer, calculates the dimensions of each region of a target clothing pattern to be completed and automatically generates the corresponding pattern based on the calculated dimensions.

The automatic pattern-generation program is developed by performing statistical processing involving correlation analysis and regression analysis on body-type-specific body measurements (angles and lengths) obtained from multiple selected subjects, together with the measurements of each region of reference patterns tailored to the respective subjects. From these analyses, calculation formulas capable of determining the dimensions of each region of a target pattern to be completed are derived and encoded into the program.

The present invention will now be described in more detail below.

First, the present invention provides a method for automatically generating a clothing pattern suitable for the human body through simple dimensional measurement and data input. The method includes developing an automatic pattern-generation program configured to automatically generate a clothing pattern upon input of the measured body measurements, and installing the program on a computer.

The inventors of the present invention conducted research on methods for drafting clothing patterns according to body type, in consideration of the fact that body shape characteristics, such as the angles of various body parts, may differ depending on age or other individual factors, and that such variations in body shape have a significant influence on clothing pattern dimensions. As a result of this research, it was confirmed that the angles and lengths of specific body parts are correlated with the dimensions of clothing patterns. Through further studies on body shape factors affecting clothing patterns, the inventors discovered that reflecting these body shape factors in the pattern drafting process enables the generation of clothing patterns that are optimally suited to individual body types.

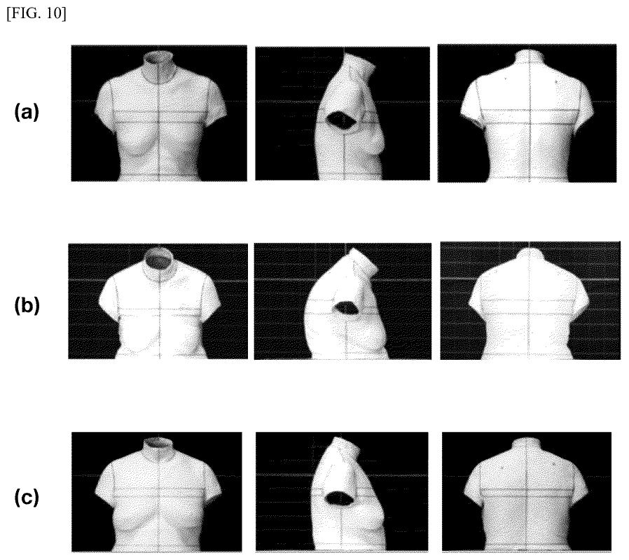

FIG. 9 is a view illustrating the characteristics of body shape and corresponding pattern features according to age. It shows the angles of various body parts, including the front neck inclination angle (a), rear neck inclination angle (b), upper chest front inclination angle (c), upper torso midline inclination angle (d), upper back inclination angle (e), and upper body axis inclination angle (f).

As shown in FIG. 9, when comparing the upper bodies of individuals of different ages, the angles of various body parts change, and the upper body tends to become thicker, indicating a variation in body shape. Accordingly, the clothing patterns required for garment construction must differ depending on age and body shape, and the collar patterns drafted based on the clothing pattern around the neck must also be adjusted.

In other words, clothing patterns should be varied according to body-shape information such as the angles of respective body parts. To achieve a better garment fit, it is necessary to use not only the lengths of the respective body parts but also their angular information when designing the clothing patterns for garment fabrication.

Accordingly, the inventors statistically analyzed the angles and lengths of body parts measured from multiple subjects, together with the dimensions of each region of reference patterns tailored to those subjects. As a result of this analysis, it was confirmed that the angles and lengths of specific body parts act as body-shape factors influencing clothing patterns. Based on these body-shape factors, calculation formulas capable of determining the dimensions of respective regions of a clothing pattern were derived, and these formulas were programmed to develop an automatic pattern-generation program, thereby completing the present invention.

To describe the process of developing the automatic pattern-generation program in more detail, various subjects of different ages and body types, including an unspecified number of subjects if necessary, are selected, and body measurements of each predetermined part are obtained from the selected subjects.

Hereinafter, in this specification, the data acquired from the subjects for developing the automatic pattern-generation program-namely, the body measurements (angles and lengths) of each predetermined body part-will be referred to as “body-type-specific body measurements.”

The body-type-specific body measurements required for developing the automatic pattern-generation program, which serves as a preliminary step of the present invention, may be obtained by directly measuring the actual bodies of the subjects. However, it is preferable to obtain the body-type-specific body measurements by fabricating human body models that accurately replicate each subject's physique and then measuring the angles and lengths (including the circumference, width, and thickness of predetermined body parts measured in units of length) from the respective human body models.

When directly measuring the bodies of actual subjects, a significant amount of time and cost is required due to repeated experiments needed to ensure accuracy. Moreover, physical fatigue and repetition may lead to inconsistencies in posture among the subjects. To overcome these limitations, specific human body models for each subject are fabricated and used for measurement.

In the process of fabricating a human body model, plaster is applied to each subject's body, allowed to harden, and then removed to produce a plaster mold. A release agent and liquid resin are sequentially applied to the inner surface of the plaster mold, and after the liquid resin is cured, the mold is separated to complete the human body model.

As the material for the human body model, fiber-reinforced plastic (FRP) may be used, and more preferably, glass-fiber-reinforced plastic (GFRP) may be employed.

Once the human body models for each subject are fabricated as described above, body-type-specific body measurements, namely, the angles and lengths of each predetermined body part (including the circumference, width, and thickness of the predetermined body parts measured in units of length) of the human body model, are measured using a tape measure and a protractor.

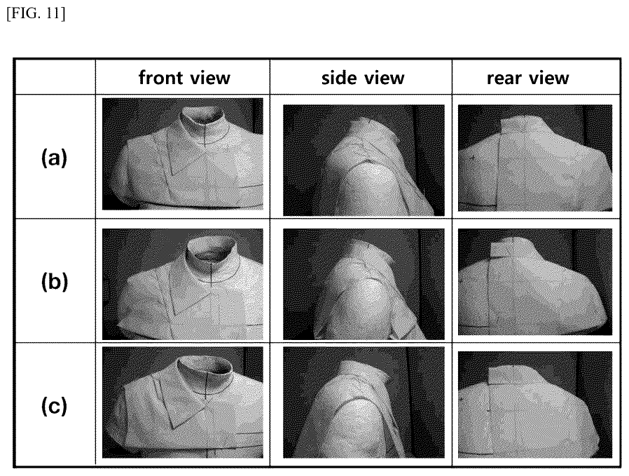

In addition to the use of a tape measure and a protractor, a photogrammetric method may also be employed. FIG. 10 is a view illustrating the photogrammetric method. As shown in FIG. 10, photographs of the front, side, and rear of each human body model are taken against a scale background board marked with grid lines, and the angles and lengths of predetermined body parts are measured using the scale markings shown in the photographs.

It is, of course, also possible to use both tape measurement and photogrammetry together. In addition, an angle-measuring instrument such as a protractor (for example, a horizontal protractor) may be additionally used to measure inclination angles.

Next, a three-dimensional cutting process is performed on each human body model using cotton fabric to obtain a pattern suitable for the body shape of the model. The obtained pattern is then unfolded into a flat form to obtain a body-fitting pattern for each model.

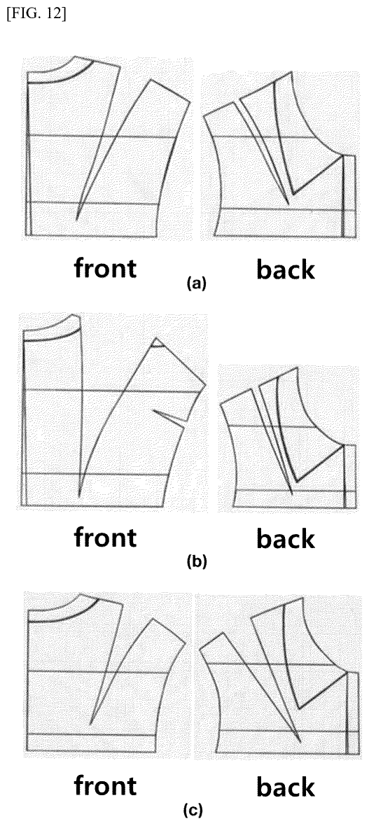

FIG. 11 is a view illustrating the process of performing three-dimensional cutting on the upper body of a human body model. Using cotton fabric or a similar material, the cutting is performed so as to conform to the body shape of the human body model, and a flat pattern is obtained by unfolding the three-dimensional cut.

After obtaining the body-fitting pattern for each model as described above, the measurements such as the lengths and angles of each predetermined region of the pattern are measured and recorded.

As shown in FIG. 11, in the case of three-dimensional cutting of the upper body, both the main-body pattern and the collar pattern are fabricated and collected. The dimensions of each predetermined region, such as lengths and angles, are then measured from the collected main-body and collar patterns.

Of course, the measurement points on the main-body and collar patterns are predetermined and identical for all human body models without difference therebetween, ensuring that measurements are consistently taken from the same locations.

In addition, for the collar pattern, certain specific measurements (for example, items \textcircled{1}, \textcircled{2}, \textcircled{3}, \textcircled{4}, and \textcircled{5} shown in FIG. 15) may be fixed, while the measurements of other regions are varied in uniform ratios for each human body model to produce multiple collar patterns. The measurements of the same predetermined portions are then taken for each of these collar patterns.

Hereinafter, for clarity of description, the body-fitting pattern obtained by performing three-dimensional cutting on a human body model using cotton fabric will be referred to as a “reference pattern.” The measurements for each region taken from the reference pattern, which is tailored to fit each subject (human body model), will be referred to as the “pattern element dimensions” of the pattern.

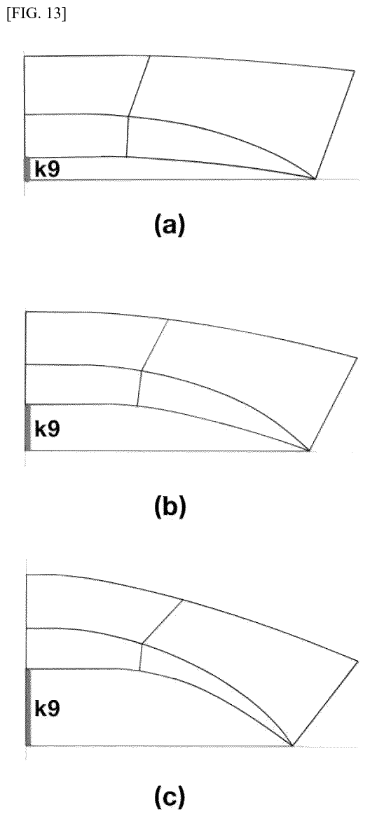

FIGS. 12 and 13 are views illustrating examples of reference patterns-namely, upper-body main-body patterns and collar patterns-obtained by performing three-dimensional cutting on human body models. The main-body patterns shown in FIG. 12 were obtained from the human body models illustrated in FIGS. 10(a), 10(b), and 10(c), respectively, while the collar patterns shown in FIG. 13 were obtained from the human body models illustrated in FIGS. 11(a), 11(b), and 11(c), respectively.

Referring to FIG. 13, the dimension indicated as k9, that is, the collar-rise dimension, varies significantly depending on the upper-body shape. In garment design, the collar-rise dimension defines the curvature along which the collar joins the neckline of the main-body pattern. It is an essential measurement, along with the neck circumference, but it is one of the most difficult parameters to predict accurately when drafting a collar pattern.

In particular, if a collar-rise dimension that does not take the wearer's body shape into account is applied during collar-pattern production, the resulting garment may exhibit mismatching between the collar and the main-body pattern, wrinkling or bulging around the neckline, or inaccurate fitting to the wearer's body.

Therefore, when generating a collar pattern, it is important to calculate the collar-rise dimension in a manner that reflects the upper-body shape of the clothing consumer (wearer).

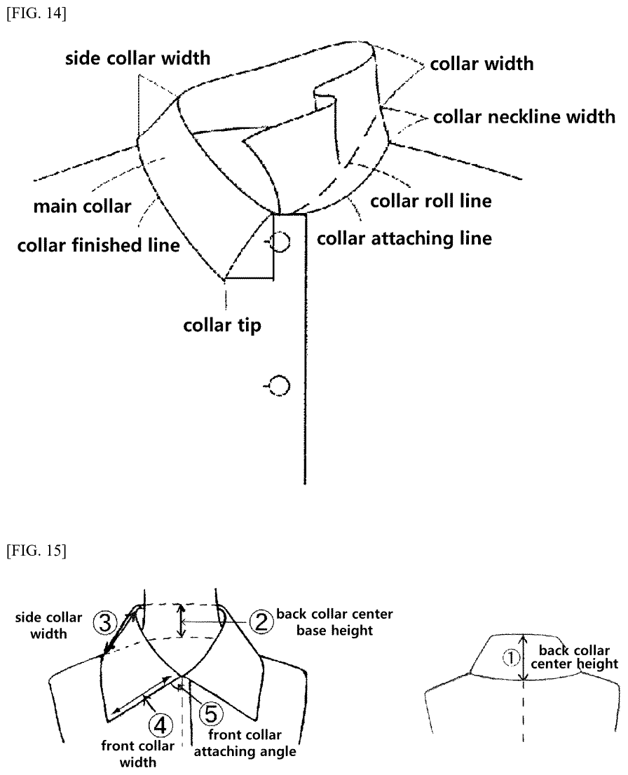

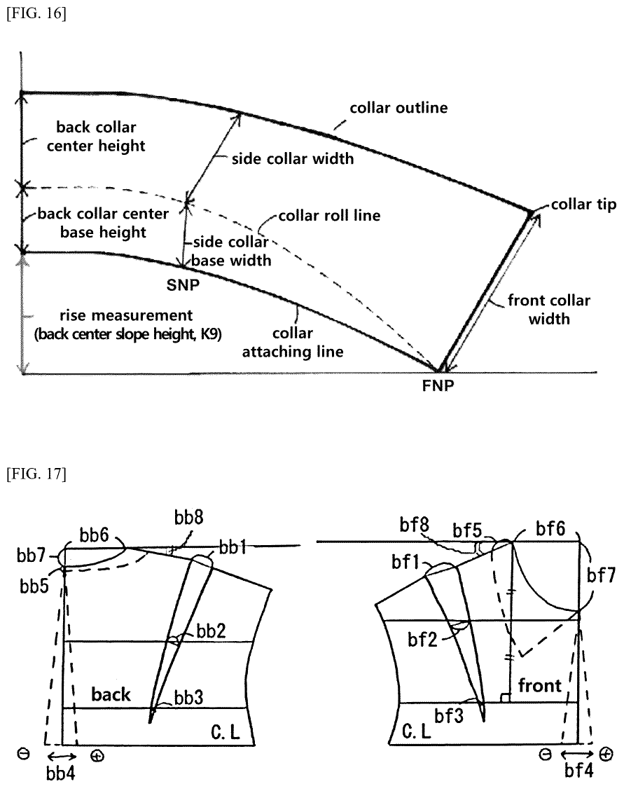

For reference, FIGS. 14 and 15 are views illustrating the names of respective parts of a shirt collar to aid understanding, and FIG. 16 is a view illustrating the names of respective parts of a collar pattern used for producing a shirt collar.

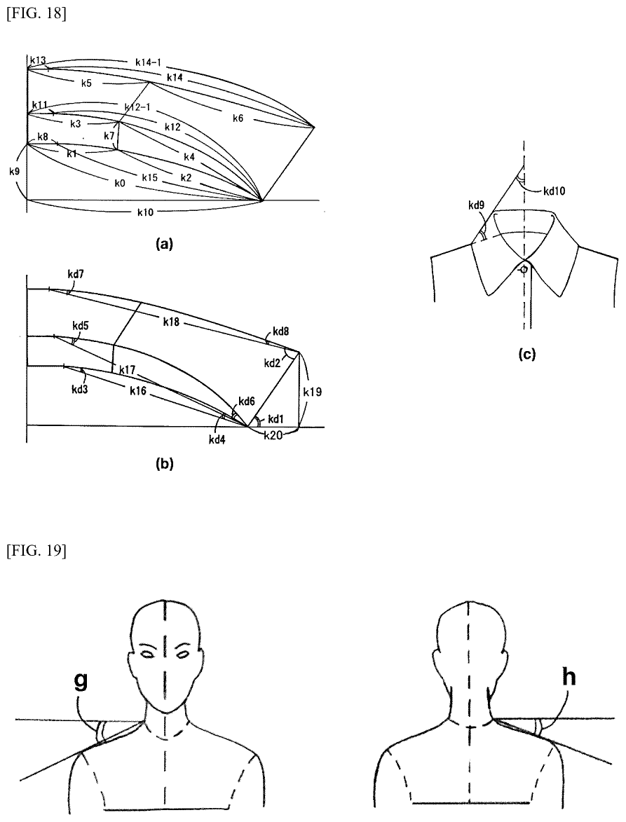

In addition, FIGS. 17 and 18 are views illustrating the measurement regions of the reference patterns obtained through three-dimensional cutting of each human body model. FIG. 17 shows the front and rear reference patterns corresponding to the upper body, while FIG. 18 shows the reference pattern for the collar.

As shown in FIGS. 17 and 18, the pattern-element dimensions are obtained by measuring the angles and lengths of each predetermined measurement region in the reference pattern. These pattern-element dimensions are then used, together with the body-type-specific body measurements obtained from the human body models, to derive a calculation formula (regression equation), as described below.

The measurement regions of the reference patterns illustrated in FIGS. 17 and 18—namely, the regions from which the pattern-element dimensions are obtained—are merely illustrative examples, and the present invention is not limited thereto.

Meanwhile, the body data acquired from the subjects, namely, the body-type-specific body measurements measured from each subject's human-body model, and the pattern-element dimensions obtained from each reference pattern are analyzed to derive a calculation formula capable of determining the dimensional values of respective regions of the target pattern based on the actual measured body measurements.

Hereinafter, as used herein, the term “target pattern” refers to the clothing pattern required to manufacture a garment for a clothing consumer, that is, the clothing pattern serving as the final output intended by the present invention. This target pattern is created to reflect the individual body type of the clothing consumer, and the final garment desired by the consumer is produced based on this target pattern.

In the present invention, the target pattern is automatically generated by a computer-based automatic pattern-generation program, which constructs the pattern on the basis of the variables input into the automatic pattern-generation program.

In the present invention, the term “actual measured body measurements” refers to the physical measurements obtained by directly measuring specific body parts of the clothing consumer in order to produce the desired garment. Specifically, it denotes body measurements such as angles and lengths (including the circumference, width, and thickness of predetermined body parts measured in units of length) taken from the clothing consumer for generating the target pattern.

In the following description, the term “pattern-element dimensions for pattern generation” refers to the dimensional values of each region of the pattern required to generate the target pattern. These dimensions are calculated by the formulas embedded in the automatic pattern-generation program using the actual measured body measurements as input variables. Based on the pattern-element dimensions obtained from these formulas, the automatic pattern-generation program constructs and generates the target pattern necessary for actual garment manufacture.

Hereinafter, the process of deriving the calculation formulas for obtaining the dimensional values at each position of the target pattern will be described in detail. Statistical analyses, including correlation analysis and regression analysis, are performed on the previously obtained body-type-specific body measurement data and pattern-element dimension data. Through these analyses, calculation formulas defining the relationship between the body type of the subject (human body model) and the corresponding pattern shape are derived.

In this process, correlation analysis is conducted to identify the physical characteristics of the subject's (human-body model's) body type, such as the neck and shoulder shape, obtained as body-type-specific body measurements, and to extract the body-shape factors that influence the pattern configuration. Using the previously obtained body-type-specific body measurement data and pattern-element dimension data as variables, the correlation between the two sets of variables is analyzed. Through this analysis, body-type-specific body measurement items exhibiting a high degree of correlation with specific pattern-element dimensions are extracted as body-shape factors that affect the pattern.

Subsequently, based on the results of the correlation analysis, regression analysis is performed to establish the quantitative relationships between the body-type-specific body measurement data and the pattern-element dimension data. Multiple body-type-specific body measurement items exhibiting high correlation coefficients with the pattern-element dimensions as a result of the correlation analysis are used as independent variables in the regression analysis, thereby deriving regression equations for each region of the target pattern. These regression equations are then used to calculate the dimensional values of each region of the target pattern, namely, the pattern-element dimensions required for pattern generation.

The derived regression equations are used as calculation formulas for determining the dimensions of each region of the pattern required for generating the target pattern. In each individual calculation formula for determining the dimension of a pattern part, the variables include the actual measured body measurements obtained from the clothing consumer.

In this case, in the individual calculation formulas for determining the dimensions of respective parts within the target pattern, the variables may consist solely of the actual measured body measurements obtained by measuring the clothing consumer's body parts. However, in addition to these actual measured body measurements, other dimensional factors may also be used as variables in the calculation formulas, for example, the dimensions of other regions within the same target pattern that have been pre-calculated, the dimensions preset and input for specific parts of the target pattern, or the dimensions of other pre-calculated patterns (for example, when the target pattern is a collar pattern, the dimensions of highly correlated regions within a previously generated body pattern).

In other words, calculation formulas may be derived and applied in which, in addition to the actual measured body measurements, the variables include the dimensions of other regions within the target pattern that have been pre-calculated or arbitrarily preset, or the dimensions of other previously generated patterns.

For example, when generating a collar pattern, in addition to the actual measured body measurements, the dimensions of other regions within the collar pattern that have been previously determined through separate calculation formulas may be additionally used as variables. Alternatively, preset dimensional values for specific regions within the collar pattern that are input in advance into the automatic pattern-generation program may also serve as variables. Furthermore, the dimensions of a pre-calculated body pattern, separate from the collar pattern, may likewise be used as additional variables.

Table 2 below presents examples of calculation formulas. These examples illustrate the use of multiple regression equations, derived through regression analysis, as the calculation formulas. Specifically, the table shows the formulas for calculating the dimensions of kd1 (see FIG. 18, collar front-center angle) and k9 (see FIG. 18, collar-rise dimension), which are among the individual formulas required for generating the collar pattern as the target pattern.

TABLE 2

| | | | | | | r | | [symbol] |
|---|---|---|---|---|---|---|---|---|
| Y | X | | Partial | | | Partial | B | Multiple |
| Dependent | Independent | | Regression | | e | Correlation | Contribution | Regression |
| Variable | Variable | | Coefficient | | Constant | Coefficient | Rate | Equation |
| [symbol] | X₁ | [symbol] | B [symbol] | [symbol] | 74.145 | [symbol] | 90.80% | [symbol] |
| | X₂ | [symbol] | B [symbol] | [symbol] | | | | |
| | X₃ | b | B [symbol] | −0.104 | | | | |
| | X [symbol] | d | B [symbol] | [symbol] | | | | |
| | X [symbol] | K9 | B [symbol] | [symbol] | | | | |
| k9 | X [symbol] | [symbol] | B [symbol] | [symbol] | [symbol] | [symbol] | [symbol] | |
| | X [symbol] | [symbol] | B [symbol] | 0.929 | | | | |
| | X [symbol] | b | B [symbol] | [symbol] | | | | |
| | X [symbol] | [symbol] | B [symbol] | [symbol] | | | | |
| | X [symbol] | [symbol] | B [symbol] | [symbol] | | | | |
| | X [symbol] | [symbol] | B [symbol] | [symbol] | | | | |
| | X₇ | [symbol] | B [symbol] | −0.107 | | | | |
| | X [symbol] | [symbol] | B [symbol] | [symbol] | | | | |
| | X [symbol] | [symbol] | B [symbol] | [symbol] | | | | |

[symbol]

indicates data missing or illegible when filed

Hereinafter, in the case of generating the final collar pattern as the target pattern, the symbols representing the dimensions of each region of the target collar pattern will be described using the same symbols as those defined for the collar pattern of the reference pattern shown in FIG. 18.

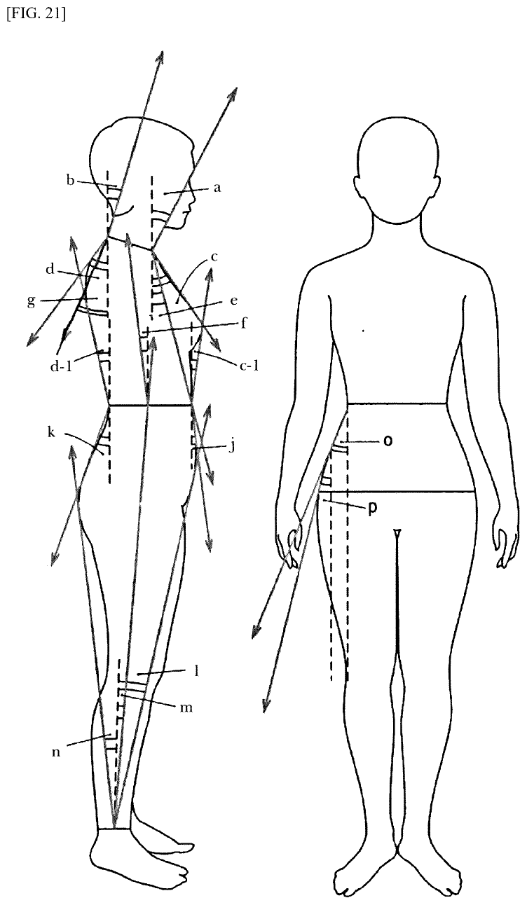

In the target collar pattern, k9 corresponds to the rise dimension (collar back-center slope height) shown in the collar pattern (reference pattern) of FIG. 18. The symbol \textcircled{1} denotes the collar back-center height illustrated in FIG. 15. The symbol bf5 denotes the collar-silhouette length shown in FIG. 24, which will be described below; bb7 denotes the back-neck depth shown in FIG. 24; G denotes the front-center length shown in FIG. 24; and g denotes the front-shoulder angle shown in FIG. 24.

The parameters \textcircled{1}, bf5, bb7, G, and g represent essential key variables that have high correlation in the calculation formula (multiple regression equation) used to determine the collar-rise dimension k9 of the collar pattern (see FIG. 24). In addition, other types of input variables may also be further defined in the calculation formula for calculating k9.

The calculation formula (multiple regression equation) for determining the collar-rise dimension k9 shown in Table 2 illustrates an example of a calculation formula used to generate the collar pattern as the target pattern. However, the calculation formula for determining the collar-rise dimension according to the present invention is not limited to the specific formula shown in Table 2.

In Table 2, kd1 denotes the collar front-center angle of the collar pattern, as shown in FIG. 18. This value is calculated using the design variables, namely the collar back-center height \textcircled{1} and the collar-silhouette length bf5, together with the actual measured body measurements and [symbol] shown [symbol] in FIGS. 22 and 23.

Subsequently, several calculation formulas (region-specific regression equations) for calculating the dimensions of respective regions within the target pattern, such as the multiple regression equations shown in Table 2, are programmed to develop the automatic pattern-generation program, which is then installed on a computer.

Once the automatic pattern-generation program is installed on the computer as described above, when it becomes necessary to create the clothing pattern required for manufacturing the actual garment of a clothing consumer, the consumer or a store salesperson measures the required actual body measurements of the clothing consumer. The measured actual body measurements are then input into the automatic pattern-generation program on the computer.

At this stage, various methods may be employed to measure the actual body measurements of the clothing consumer. These methods include tape measurement, in which the lengths of specific body parts, including the circumferences of the neck, chest, waist, arms, and legs, are measured using a tape measure; angle measurement, in which the angles of specific body parts, including the shoulder-slope angle, are measured using a protractor (e.g., a horizontal protractor); and photo measurement, in which the front, back, and left and right sides of the body are photographed against the scale background board, and the angles, lengths, and widths of each body part are determined using the scale markings visible in the photographs.

Such measurement of actual body measurements can be easily performed by non-experts such as clothing consumers or store salespeople. The actual body measurements obtained by them are input into the automatic pattern-generation program installed on the computer as variables for generating the target pattern.

Of course, the measured actual body measurements may be directly entered as variables into the automatic pattern-generation program installed on the computer at the site where the clothing consumer's measurement is performed.

Alternatively, the measurement data entered on the on-site computer may be transmitted to a remote computer via a wired or wireless communication network, and then input as variables into the automatic pattern-generation program installed on the remote computer.

Alternatively, when the clothing consumer or a store salesperson takes photographs using an application (App) installed on a smart device such as a smartphone or tablet PC, the actual measured body measurements of the clothing consumer may be calculated or extracted from the photographs captured by the application. The actual measured body measurements obtained by the application may then be automatically transmitted to, and entered as variables into, a computer equipped with the automatic pattern-generation program.

During photo measurement, since left-right asymmetry may exist in the body, it is preferable to photograph not only the front and back but also both sides of the body. This enables accurate determination of the angles and lengths (including the width, thickness, and circumference) of each body region.

Once the actual measured body measurements of the clothing consumer are input as variables into the automatic pattern-generation program as described above, the program calculates the dimensional values of each region of the target pattern using the corresponding location-specific (body part-specific) calculation formulas. Based on the calculated dimensional values for each region, the automatic pattern-generation program automatically generates a target pattern having a shape corresponding to those dimensions.

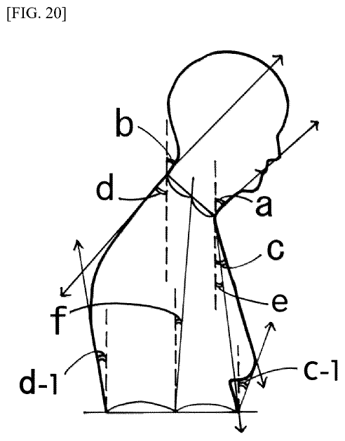

FIGS. 19 to 23 illustrate actually measured body measurement regions serving as input variables for the automatic pattern-generation program. As shown in these drawings, the angles, lengths, and other dimensions of various body parts of the consumer may be measured. The measured actual body-measurements are then input as variables into the automatic pattern-generation program and utilized to generate target patterns such as a collar pattern.

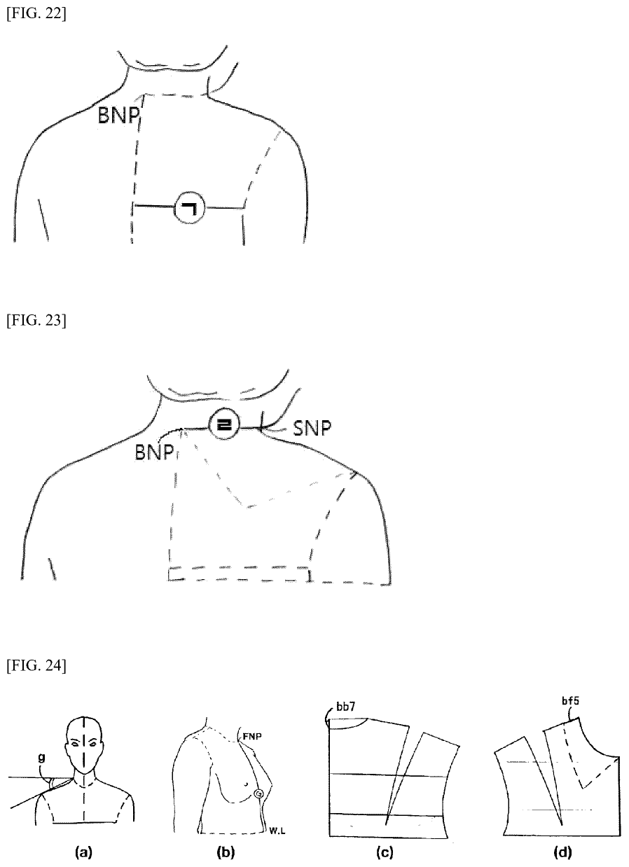

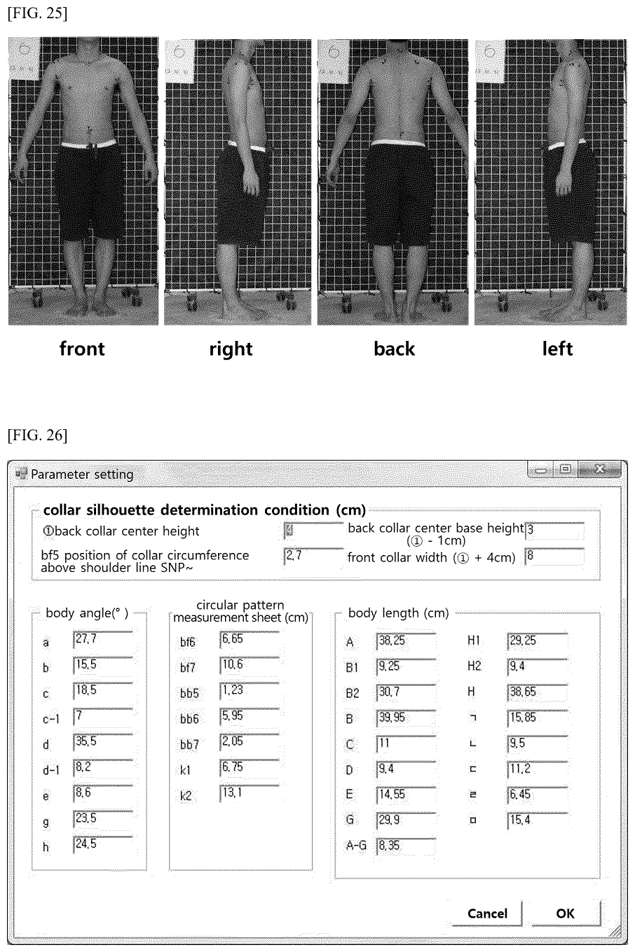

In addition, FIG. 24 is a view illustrating major variable items used for calculating the collar-rise dimension of the collar pattern. FIG. 25 a view illustrating an example of photo measurement, and FIG. 26 a view illustrating an example of an input screen of the automatic pattern-generation program.

Referring to FIG. 25, the consumer for whom the garment is to be produced is positioned in front of a scale background board, and a photograph is taken. Using the scales visible in the photograph, the dimensions (angles and lengths) of each body part, such as those illustrated in FIGS. 19 to 23, are measured.

FIG. 26 illustrates an example of an input screen of a program for automatically generating a collar pattern. Among the input variable items, items such as \textcircled{1} (see FIG. 15), bf5 (see FIGS. 17 and 24), and the collar back-center waist height (see \textcircled{2} in FIG. 15) are design variable items that are preset and entered in advance. Each item under the human-body angle and human-body length sections represents an actual body-measurement value, while the items labeled as longitudinal pattern measurement values correspond to the measurements obtained from the body pattern (for example, k1 (back-neck circumference) and k2 (front-neck circumference) may be preset and entered as required).

The variable bb7 (back-neck depth), which is a measurement item from the body pattern, is one of the key variables used to calculate the collar-rise dimension when generating the collar pattern as the target pattern, as shown in FIG. 24.

Furthermore, when generating the final target pattern (collar pattern) based on the dimensions obtained by the automatic pattern-generation program, there are not only straight-line sections within the target pattern but also curved sections that need to be drawn. For example, as shown in FIG. 18, the automatic pattern-generation program must be developed to draw curved portions such as k14, k12, and k15 in the collar pattern.

To this end, the automatic pattern-generation program may be developed to construct curved sections within the pattern using the Hermite curve drawing method, which draws curves based on a distance between two points and angles at those points.

For example, within the automatic pattern-generation program, curve k14 may be drawn using the angle values kd7 and kd8, along with the distance value k18; curve k12 may be drawn using the angle values kd5 and kd6, and the distance value k17; and curve k15 may be drawn using the angle values kd3 and kd4, and the distance value k16.

At this time, the angle values at each point and the distance values between the two points may be calculated through predetermined formulas derived from other pre-calculated measurements within the target pattern (collar pattern).

In this way, according to the present invention, after measuring and obtaining the actual body measurements of predetermined body parts of a clothing consumer, such as angles or lengths (including circumference, width, and thickness measured in units of length), the automatic pattern-generation program automatically generates the desired clothing pattern (target pattern) by using the acquired actual body measurements as input variables. The automatically generated clothing pattern may include a body pattern for an upper garment, a collar or sleeve pattern joined to the upper body pattern, or various lower clothing patterns such as skirts or pants.

That is, using the actual measured body measurements illustrated in FIGS. 19 to 23, various partial body patterns for upper or lower garments may ultimately be generated, or collar patterns or sleeve patterns joined to the body pattern of upper garments may be generated.

For example, in the case of a collar pattern, each dimension shown in FIG. 18 is obtained using calculation formulas within the automatic pattern-generation program. The variables of each calculation formula may consist solely of actual measured body measurements depending on the specific area within the collar pattern. However, as previously described, in addition to the actual measured body measurements, the variables may also include dimensions of other body parts calculated in advance within the collar pattern, dimensions of other related patterns (such as the body pattern) related to the collar pattern (for example, bb7 in FIG. 24, which is used to calculate the collar-rise dimension), or dimensions (such as bf5) that are preset and input into the automatic pattern-generation program from the beginning.

Of course, the calculation formulas for each pattern part may be regression equations that use as variables the items with high correlation coefficients derived from correlation analysis between the body-type-specific body measurements of the subjects (human body models) and the pattern element dimensions of the reference patterns.

However, when deriving the regression equation, variables that have high correlation coefficients with the pattern element dimensions, such as body-type-specific body measurements, measurements of other body parts within the reference pattern, or measurements of other patterns (for example, body pattern dimensions in the calculation formulas for each collar pattern part), are selected and used to derive and apply the regression equation.

The automatic pattern-generation program constructed as described above is stored in a server or computer. As previously described, when the actual measured body measurements of the consumer are obtained through consumer's photographs taken and transmitted via a mobile device, the measured data are input into the automatic pattern-generation program, which then automatically generates a pattern. The automatically generated pattern may be provided to the clothing consumer or to the garment manufacturer through a mobile device. For example, based on the actual measured body measurements of the consumer acquired from the consumer's photograph, several partial body patterns for upper or lower garments suitable for the consumer may be generated, or collar or sleeve patterns that join to the body pattern of an upper garment may be generated. The generated pattern may then be transmitted to the garment manufacturer's mobile device, allowing the final garment to be created using the pattern optimized for the clothing consumer.

While the embodiments of the present invention have been described in detail above, it should be understood that the scope of the present invention is not limited thereto. Various modifications and improvements that may be made by those skilled in the art using the fundamental concepts of the present invention, as defined in the following claims, are also included within the scope of the present invention.

1. A method for measuring body measurements and automatically generating clothing patterns for non-face-to-face custom-made clothing ordering and manufacturing, the method comprising:
selecting multiple subjects and measuring the dimensions of each predetermined body part of each subject to obtain actual measured body measurements of the subject;
measuring the dimensions of each predetermined body part from photographs taken of each subject;
deriving a regression equation for calculating actual body measurements of a clothing consumer from the body measurements in photographs taken of the clothing consumer, by performing statistical processing involving correlation analysis and regression analysis between the actual measured body measurements of the subject and the measurements of each body part of each subject measured in the photographs;
developing a measurement program based on the regression equation to calculate the actual body measurements of the clothing consumer from the body measurements in the photographs taken of the clothing consumer, and storing the program on a server;
capturing an image for measuring the body measurements of the clothing consumer using a portable mobile terminal, and transmitting the captured image to the server from the mobile terminal;
measuring, by the server, the dimensions of predetermined body parts from the image taken of the clothing consumer using the measurement program; and
inputting the measurements of the body parts measured from the photographs of the clothing consumer as input variables into the measurement program, such that the actual measured body measurements of each body part of the clothing consumer are calculated by the measurement program.

2. The method according to claim 1, wherein the actual measured body measurements of the subject include at least one selected from the group consisting of the measurements of an angle of a body part, and a length, circumference, width, or thickness of the body part measured in units of length.

3. The method according to claim 1, wherein, in the step of measuring the dimensions of each predetermined body part from the photographs of the subjects and the clothing consumer, the subject and the clothing consumer are photographed together with a size measuring member formed of a standardized product, and the dimensions of each body part are measured in proportion to the dimensions of the photographed size measuring member.

4. The method according to claim 3, wherein multiple photographs are taken by changing, at predetermined angular intervals, the direction in which the subject and the clothing consumer are standing against the size measuring member.

5. The method according to claim 4, wherein the direction in which the subject and the clothing consumer are standing is changed in 45° increments, and photographs are taken in a total of eight directions including the front, back, left, and right sides of the subject.

6. The method according to claim 4, wherein multiple photographs are taken at different photographing distances for each direction in which the subject and the clothing consumer are standing, and
the unit of change in the photographing distance is defined as the length of one or more size measuring members arranged in a straight line in one direction.

7. The method according to claim 6, wherein, when deriving a regression equation for calculating the actual measurements of each body part of a clothing consumer from the body measurements in photographs taken of the clothing consumer, statistical analysis is performed for each photographing distance to derive multiple regression equations distinguished by photographing distance for each body part, and the regression equation corresponding to the photographing distance at which the photograph of the clothing consumer is taken is selected and used to calculate the actual body measurements of the clothing consumer.

8. The method according to claim 1, wherein the body part of the subject whose actual body measurements are measured and the body part whose measurements are obtained from the photograph of the subject are defined as the same body part.

9. The method according to claim 1, wherein, during the statistical processing involving correlation analysis and regression analysis, the correlation between the actual measured body measurement data of each subject and the body part measurement data of each subject obtained from photographs is analyzed as variables, photographic body measurement items having correlation with the actual measured body measurements are extracted, and a regression analysis is performed using the photographic body measurement items having correlation with the actual measured body measurements of the subject as independent variables to derive the regression equation.

10. The method according to claim 1, wherein the regression equation is a regression equation that uses, as variables, both the dimensions of body parts measured in photographs of the clothing consumer and the actual measured body measurements of other body parts of the clothing consumer that have been pre-calculated.

11. The method according to claim 1, further comprising:
generating a reference pattern fitted to the body shape of each of the multiple subjects, and measuring pattern element dimensions, which are the measurements of predetermined regions within each reference pattern;
performing statistical processing involving correlation analysis and regression analysis between the body-type-specific body measurements and the pattern element dimensions to derive a regression equation for calculating the dimensional values of each region within a target pattern from the body measurements obtained for the clothing consumer;
based on the regression equation, calculating the dimensional values of each region within the target pattern from the body measurements of the clothing consumer obtained from photographs taken of the clothing consumer, and developing an automatic pattern-generation program that uses the calculated dimensional values of each region to generate the target pattern, and storing the program on a server;
inputting, by the server, the body measurements of the clothing consumer as input variables into the automatic pattern-generation program, so that the target pattern for the clothing consumer is automatically generated by the automatic pattern-generation program; and
providing the automatically generated target pattern of the clothing consumer to a mobile terminal of the clothing consumer or of a garment manufacturer.

12. The method according to claim 11, wherein the body measurements of the clothing consumer include at least one selected from the group consisting of the measurements of an angle of a body part, and a length, circumference, width, or thickness of the body part measured in units of length.

13. The method according to claim 11, wherein, in the step of obtaining the body-type-specific body measurements, a human body model replicating the body of each subject is fabricated, and the body measurements of each body part are measured using each human body model to obtain the body-type-specific body measurements.

14. The method according to claim 13, wherein the human body model is fabricated by applying plaster to the body of each subject, allowing the plaster to harden, then separating it to produce a plaster mold, applying a release agent and liquid resin to an inner surface of the mold, and separating the hardened resin from the mold.

15. The method according to claim 13- or 14, wherein the human body model is made of a fiber-reinforced plastic material.

16. The method according to claim 13, wherein the step of obtaining body-type-specific body measurements comprises photographing each human body model together with a size measuring member, and measuring the dimensions of each predetermined body part in proportion to the dimension of the size measuring member shown in the captured images.

17. The method according to claim 13, wherein, when generating a reference pattern suitable for each subject's body type, each human body model is used to create a reference pattern corresponding to the body shape of the human body model.

18. The method according to claim 11, wherein the pattern element dimensions are angle and length measurements taken from predetermined regions within the reference pattern.

19. The method according to claim 11, wherein, during the statistical processing involving correlation analysis and regression analysis, the correlation between the body-type-specific body measurement data and the pattern element dimension data is analyzed as variables, body-type-specific body measurement items having correlation with the pattern element dimensions are extracted, and a regression analysis is performed using the extracted body-type-specific body measurement items as independent variables to derive the regression equation.

20. The method according to claim 11, wherein the regression equation uses, as variables, at least one selected from the group consisting of the measurements of a body part measured for a clothing consumer, pre-calculated measurements of another body part within the target pattern, preset measurements input in advance for a specific body part within the target pattern, and pre-calculated measurements of another target pattern that constitutes a clothing pattern for manufacturing a garment together with the target pattern.

21. The method according to claim 11, wherein the automatic pattern-generation program is configured to draw curved portions within the target pattern using the Hermite curve drawing method, which draws curves based on a distance between two points and angles at those points.

22. The method according to claim 11, wherein the body part of the subject whose actual body measurements are measured and the body part whose measurements are obtained from the photograph of the subject are defined as the body parts for which dimensional measurements are required when drafting a clothing pattern.
